(19) United States
(12) Patent Application Publication
(10) Pub. No.: US 2008/0295026 A1
(43) Pub. Date: Nov. 27, 2008

(54) METHOD AND APPARATUS FOR DISPLAYING APPLICATION PROGRAM AND MENU

(75) Inventor: Moon-sang LEE, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/923,690

(22) Filed: Oct. 25, 2007

(30) Foreign Application Priority Data
May 21, 2007 (KR) 10-2007-0049308

(51) Int. Cl. G06F 3/048

(52) U.S. Cl. 715/810; 715/716

(57) ABSTRACT

Provided are a method and apparatus for displaying application program (AP) menu. The method includes creating an AP menu, for selecting at least one AP, by using data for the at least one AP; and displaying the AP menu in a predetermined area of the image display unit. The AP menu includes an initial menu that displays a plurality of icons for the at least one AP in the same predetermined area, and, if one of the plurality of icons is selected a corresponding AP is executed and displayed in the same predetermined area, or a lower level menu is displayed in the same predetermined area.

### CROSS-REFERENCE TO RELATED PATENT APPLICATION

This application claims priority from Korean Patent Application No. 10-2007-0049308 filed on May 21, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to reproducing multimedia, and more particularly, to displaying application programs (APs)/menus included in the multimedia reproducing apparatus.

2. Description of the Related Art

Various multimedia reproducing apparatuses including a digital television (TV) support APs, which provide various additional services such as a weather information service and an electronic program guide (EPG), in addition to broadcasting programs and video images.

In a related art display method as illustrated in FIG. 1, when a user opens menus for APs to execute the APs, AP menus 11, 12, and 14 are displayed in areas or locations that are different from each other in an image display unit 1 of a multimedia reproducing apparatus. In this display method of a related art, when the user consecutively executes a plurality of APs, inconsistent locations of menus will give the user a sense of instability or discomfort.

Also, FIG. 2 illustrates another related art display method for AP menus. In this display method, a main menu 21 of an AP and a lower level menu 22 are displayed on the image display unit 1 at one time. This method, however, also distracts the user from watching a multimedia reproducing apparatus.

### SUMMARY OF THE INVENTION

The present invention provides a method and apparatus for displaying APs/menus which give a user a sense of comfort and stability without distracting the user from watching a multimedia reproducing apparatus. Hereinafter, an “AP/menu” refers to a menu for selecting an AP and an executed AP selected from the menu, and an “AP menu” refers to only a menu for selecting an AP(s).

According to an aspect of the present invention, there is provided an apparatus for displaying an AP/menu, the apparatus including a display unit displaying images; a storage unit storing information on an AP; and a control unit creating an AP menu and displaying the AP menu in a predetermined area of the display unit by using the information on the AP stored in the storage unit.

According to another aspect of the present invention, there is provided a method of displaying an AP menu on an image display unit of a multimedia reproducing apparatus, the method including creating an AP menu by using information on the AP; composing an image and the AP menu in order to place the AP menu in a predetermined area of the image display unit; and displaying the composed image.

According to another aspect of the present invention, there is provided a computer-readable medium having embodied thereon a computer program for executing the method of displaying of an AP menu on an image display unit of a multimedia reproducing apparatus, the method including creating an AP menu by using information on the AP; composing an image and the AP menu in order to place the AP menu in a predetermined area of the image display unit; and displaying the composed image.

### BRIEF DESCRIPTION OF THE DRAWINGS

The above and other aspects of the present invention will become more apparent by describing in detail exemplary embodiments thereof with reference to the attached drawings in which:

FIGS. 1 and 2 illustrate related art display methods for application program (AP) menus;

FIG. 3 is a functional block diagram illustrating a structure of an AP/menu display apparatus according to an exemplary embodiment of the present invention;

FIG. 4A illustrates selecting a display area for the AP menu, in a method of displaying the AP menu according to an exemplary embodiment of the present invention;

FIGS. 4B, 4C, 5A and 5B illustrate operations of displaying AP program menus according to an exemplary embodiment of the present invention;

FIG. 5C illustrates an operation of displaying an executed AP according to an exemplary embodiment of the present invention;

FIG. 6 illustrates detailed operations of displaying an AP program/menu according to an exemplary embodiment of the present invention; and

FIG. 7 illustrates detailed operations of selecting and executing an AP, illustrated in FIG. 6.

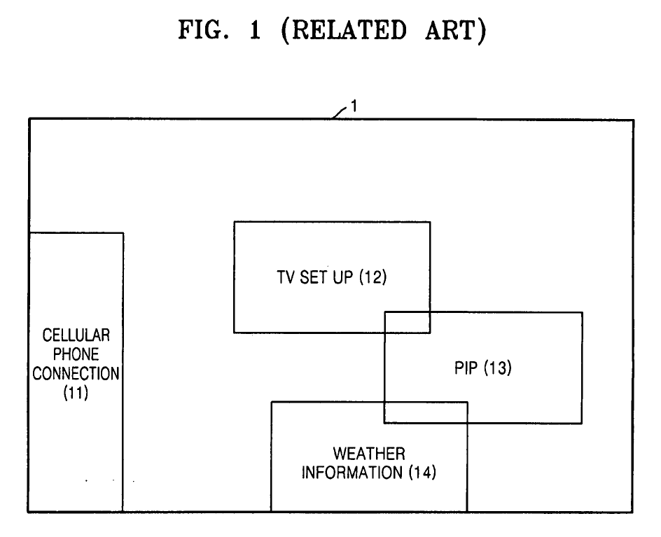

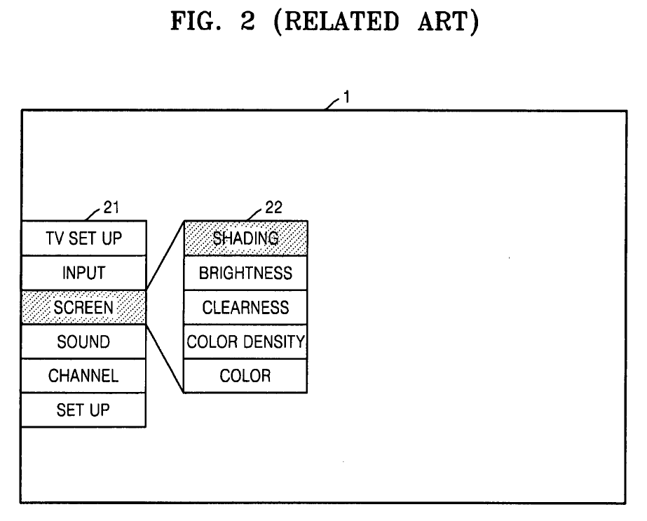

### DETAILED DESCRIPTION EXEMPLARY EMBODIMENTS

The present invention will now be described more fully with reference to the accompanying drawings in which exemplary embodiments of the invention are shown.

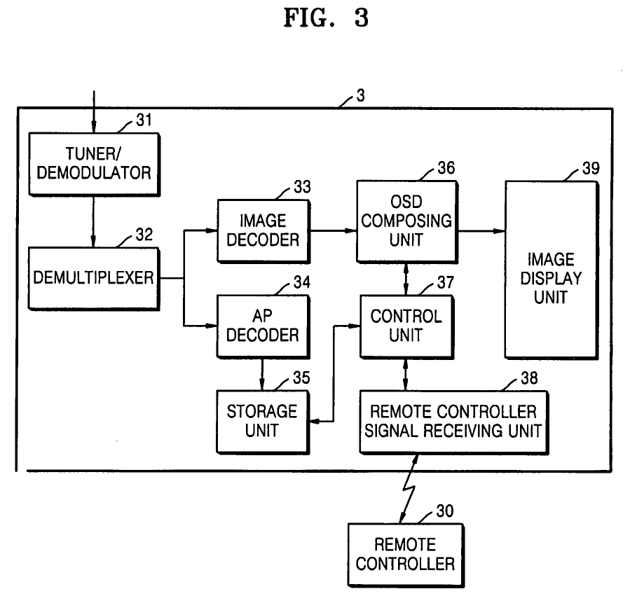

FIG. 3 is a functional block diagram illustrating a structure of an AP/menu display apparatus 3 according to an exemplary embodiment of the present invention.

As previously defined, an “AP/menu” refers to a menu for selecting an AP and an executed AP selected from the menu. Further, an “AP menu” refers to only a menu for selecting an AP such as a menu window.

The AP/menu display apparatus 3 such as a digital TV includes a tuner/demodulator 31, a demultiplexer 32, an image decoder 33, an AP decoder 34, a storage unit 35, an on screen display (OSD) composing unit 36, a control unit 37, a remote controller signal receiving unit 38, and an image display unit 39.

First, a broadcasting signal such as a transport stream received in the AP/menu display apparatus 3 passes through the tuner/demodulator 31. The tuner separates a selected broadcasting signal of a channel from the received signal. The demodulator demodulates the signal separated by the tuner.

The signal demodulated by the demodulator includes more than one broadcasting program data type, such as still images or video images, and additional information data. The additional information data includes control information needed for reproducing the broadcasting program, and AP data such as weather information data, stock information data, and electronic program guide (EPG) data. Accordingly, the demodulated signal is separated into a respective broadcasting program and additional information data by the demultiplexer 32. Among the separated data, a broadcasting program is decoded by the image decoder 33, and AP data is decoded by the AP decoder 34. The decoded AP data passes through the storage unit 35 or is directly transmitted to the control unit 37.

The storage unit 35 stores AP data decoded by the AP decoder 34.

Also, the storage unit 35 stores a plurality of execution programs for APs and interface information on APs. Examples of an AP include a TV set up program, a weather information program, a stock information program, a cellular phone connection program, an EPG, a photo viewer program, a printer connection program, and a digital camera connection program.

The programs and data stored in the storage unit 35 are used for creating an AP menu or selecting and executing a corresponding AP.

The OSD composing unit 36 composes the broadcasting program decoded by the image decoder 33 and an AP/menu in an OSD format.

An image composed by the OSD composing unit 36 is output to the image display unit 39.

The control unit 37 controls the OSD composing unit 36 in order to display the AP/menu in a predetermined area (or location) in the image display unit 39. Also, the control unit 37 creates or changes an AP menu and executes a selected AP according to a key input by a user.

The user inputs the key by using a remote controller 30 or a control panel (not shown) attached to a digital TV.

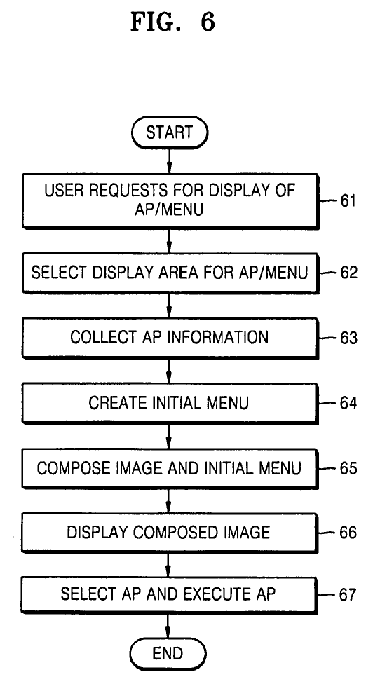

FIG. 6 is a flowchart illustrating a detailed operation of a method of displaying an AP/menu according to an exemplary embodiment of the present invention.

First, in operation 61, a user requests an AP/menu to be displayed, by using a remote controller while watching a digital TV.

In operation 62, the user selects an area in an image display unit 4 where the AP/menu is to be displayed.

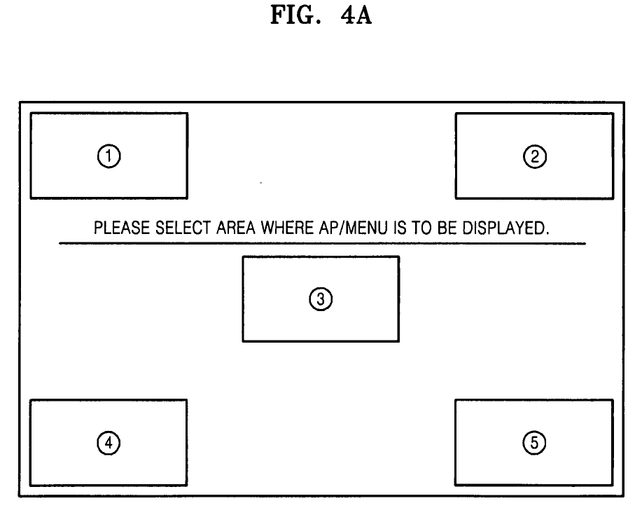

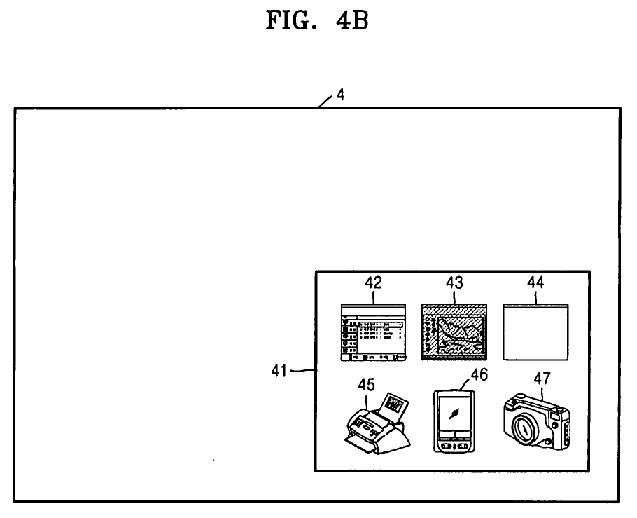

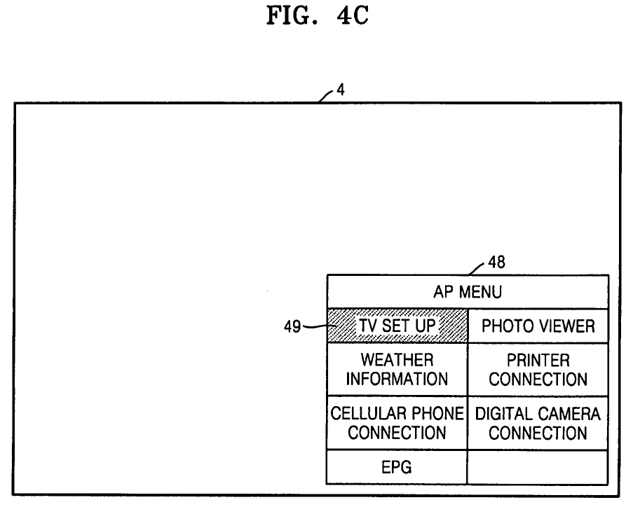

For example, as illustrated in FIG. 4A, when the user requests the AP/menu to be displayed, areas 1 through 5 in the image display unit 4 of the digital TV where the AP/menu can be displayed and a guide message are indicated. The user then selects a number which the AP/menu is to be displayed. (for example, 5 bottom right)

Operation 62 is not a mandatory operation, and may be omitted in other exemplary embodiments. In other words, when the user requests the AP/menu to be displayed, in operation 61, the AP/menu may be automatically displayed in an area predetermined by a manufacturer of the digital TV regardless of the user's wishes.

In general, digital TVs may reproduce two images at one time in a Picture-In-Picture (PIP) format. In other words, when a main image is displayed together with a sub-image, a display area for an AP/menu may be the same as a reproducing area for the sub-image.

In operation 63, information on APs such as the types of the APs currently supported by the digital TV, icons indicating the APs, and menu information that each of the APs has, is collected.

In operation 64, an initial menu for the AP/menu is created, based on collected information on the APs. Examples of the initial menu are illustrated in FIGS. 4B and 4C. An initial menu 41 in a graphic mode illustrated in FIG. 4B includes icons for various APs. An initial menu 48 in a text mode illustrated in FIG. 4C includes a list of names of the APs.

In operation 65, the initial menu created in operation 64 and an image of a broadcasting program are composed. In other words, the image and the initial menu are composed in the OSD format, in order to display the initial menu in the display area for the AP/menu predetermined in operation 62.

In operation 66, the composed image created in operation 65 is displayed in the image display unit 4, as illustrated in FIG. 4B or 4C.

In operation 67, the user selects or executes an AP that the user wants to execute by using a remote controller while watching the initial menu.

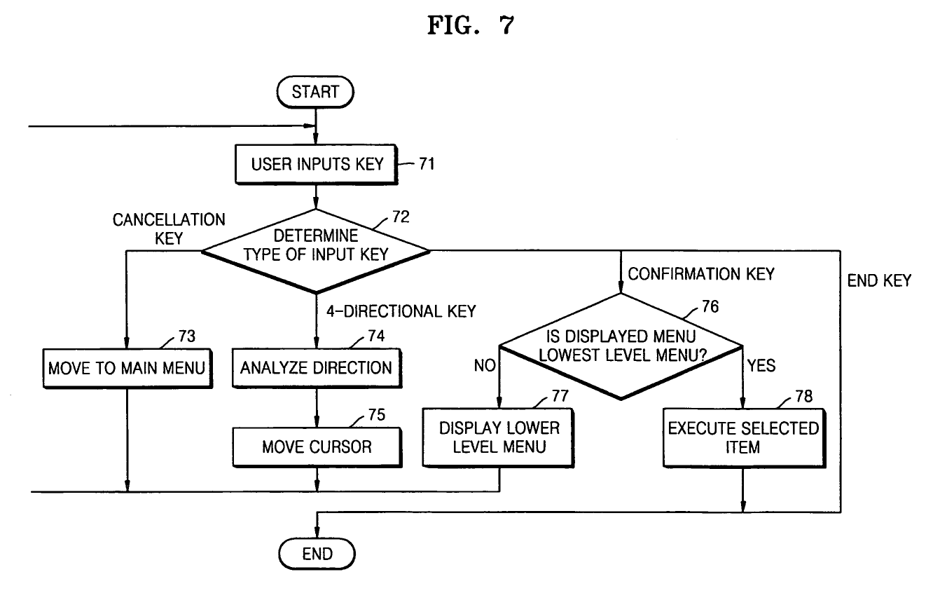

Operation 67 will be described in detail later with reference to FIG. 7.

In another exemplary embodiment of the present invention, the order of selecting a display area for a menu (operation 62) and collecting AP information (operation 63) can be changed. In other words, operation 62 and/or operation 63 can be performed prior to operation 61. Also, operation 63 can be performed prior to operation 62.

FIG. 7 illustrates detailed operations of operation 67 illustrated in FIG. 6.

First, the user inputs a remote controller key in order to select an AP from the initial menu 41 or 48 (operation 71).

Types of keys that the user can input include a “confirmation key”, “cancellation key”, “end key,” and “4-direction key”.

In operation 72, the type of the key input in operation 71 is determined.

From the result obtained in operation 72, if the input key is the “4-direction key”, a direction of the key is analyzed first (operation 74) and a cursor is then moved according to the analyzed direction (operation 75). For example, a cursor is placed at a weather information icon 43 as illustrated in FIG. 4B. Here, if the user inputs the 4-direction key, and the analyzed direction thereof is determined as a left direction, the cursor is moved to a TV set up icon 42. Then, the procedure returns to operation 71 and waits for a new key input.

From the result obtained in operation 72, if the “confirmation key” is input, it is determined whether a menu displayed in the image display unit 4 is a lowest level menu (operation 76). If the menu is not a lowest level menu, a lower level menu for an item in the current menu, at which the cursor is placed, is displayed (operation 77). On the other hand, if the menu displayed in the image display unit 4 is the lowest level menu, an item in the current menu, at which the cursor is placed, is executed (operation 78).

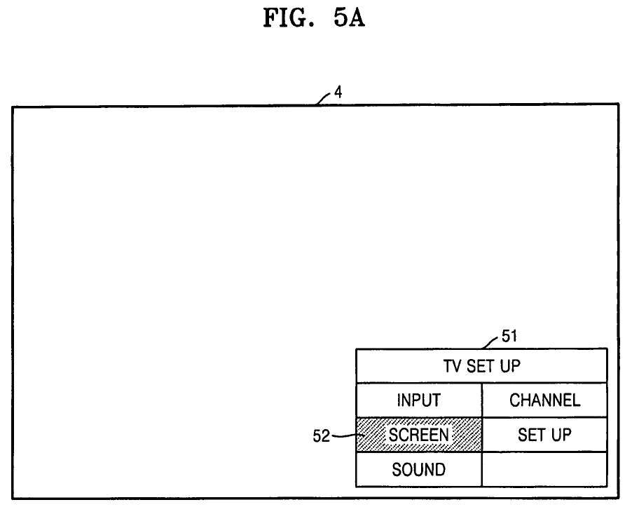

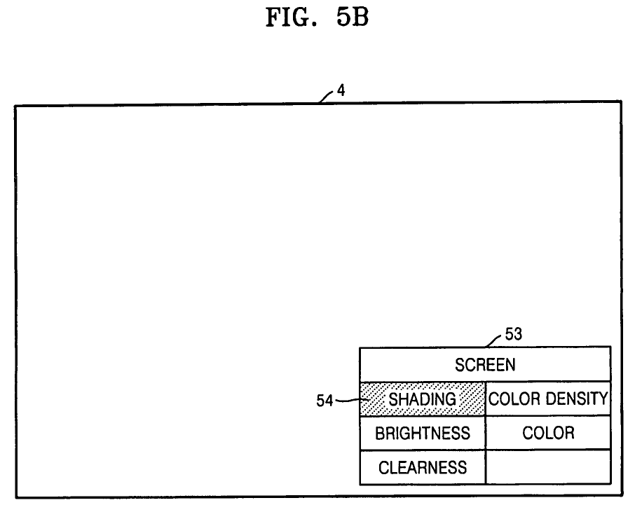

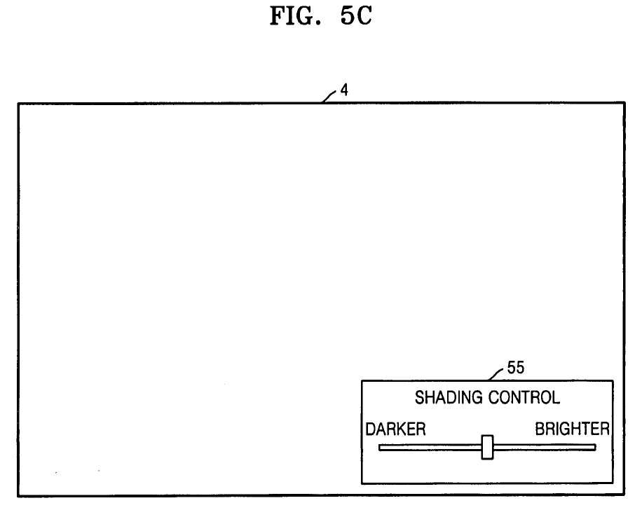

For example, in a case as illustrated in FIG. 4C, the initial menu 48 including categories indicating various APs are displayed in the image display unit 4, and a cursor is placed at the “TV set up” item 49. Here, if the user inputs the “confirmation key”, a new lower level menu 51 is displayed as illustrated in FIG. 5A, because the currently displayed initial menu 48 is not the lowest level menu. The new lower level menu 51 includes lower level items of the “TV set up” item 49. Here, an area where the lower level menu 51 is displayed is the same as the area where the initial menu 48 is displayed. Then, the procedure returns to operation 71 and waits for another key input by the user.

In the current lower level menu 51 as illustrated in FIG. 5A, the cursor is placed at a “screen” item 52. At this time, if the user inputs the “confirmation key” again (operation 71), a new lower level menu 53 is displayed as illustrated in FIG. 5B by operations 72, 76, and 77. The new lower level menu 53 includes lower level items of the “screen” item 52.

When the cursor is placed at a “shading” item 54 as illustrated in FIG. 5B, if the user inputs the “confirmation key” again, the current menu 53 will be determined as the lowest level menu (operation 76) and a “shading” control function 55 will be performed as illustrated in FIG. 5C (operation 78).

In operation 71, if the user inputs the “cancellation key,” an upper level menu will appear in the image display unit 4 (operation 73).

For example, if the user inputs the “cancellation key” while in the status as illustrated in FIG. 5B, a menu 51 of FIG. 5A which is the upper menu of the current menu 53 will appear again.

Also, the user can terminate the AP/menu display procedure by inputting the “end” key during any operation.

As described above, all of the AP menus 48, 51, and 53 and the executed AP(s) (55) are always displayed in a predetermined area (bottom right).

The digital TV is selected for an exemplary embodiment of the AP/menu display apparatus 3. However the exemplary embodiment of the present invention may apply to various multimedia reproducing apparatuses, such as a personal computer (PC) or a personal multimedia player (PMP).

A method of displaying an AP/menu according to the present invention can also be embodied as computer readable codes on a computer readable recording medium. Thus, the method of displaying the AP/menu according to the present invention can be embodied without adding a new hardware component to a related art digital computer.

The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

According to the exemplary embodiments of the present invention, all AP menus and executed APs are repeatedly displayed in a predetermined area in an image display unit. The present invention provides an apparatus and method for displaying APs/menus which give a user a sense of comfort and stability without distracting the user from watching a multimedia reproducing apparatus.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for displaying an application program (AP) menu, the apparatus comprising:
a display unit that displays an image;
a storage unit that stores data for at least one AP; and
a control unit that creates an AP menu for selecting the at least one AP, and displays the AP menu in an area of the display unit by using the data for the at least one AP.

2. The apparatus of claim 1, wherein the storage unit stores information on the area where the AP menu is displayed.

3. The apparatus of claim 2, wherein the area where the AP menu is displayed is predetermined.

4. The apparatus of claim 1, further comprising an image composing unit which composes the image and the AP menu.

5. The apparatus of claim 1, further comprising an AP decoder which decodes the at least one AP.

6. The apparatus of claim 1, wherein the AP menu comprises an initial menu that displays a plurality of icons for the at least one AP in the area.

7. The apparatus of claim 6, wherein if one of the plurality of icons is selected, a corresponding AP among at least one AP is executed and displayed in the area.

8. The apparatus of claim 6, wherein the AP menu further comprises a hierarchical lower level menu that is displayed in the area when one of the plurality of icons is selected, and
wherein the hierarchical lower level menu displays another plurality of icons with respect to the corresponding AP.

9. The apparatus of claim 8, wherein if one of the other plurality of icons is selected, the corresponding AP is executed and displayed in the area.

10. A method of displaying an application program (AP) menu on an image display unit of a multimedia reproducing apparatus, the method comprising:
creating an AP menu, for selecting at least one AP, by using data for the at least one AP;
composing an image and the AP menu such that the AP menu is displayed in an area of the image display unit; and
displaying the composed image.

11. The method of claim 10, further comprising selecting the area according to user selection.

12. The method of claim 10, further comprising collecting the data for the at least one AP.

13. The method of claim 10, wherein the at least one AP comprises at least one of a television set up program, a weather information program, a stock information program, a cellular phone connection program, an electronic program guide (EPG), a photo viewer program, a printer connection program, and a digital camera connection program.

14. The method of claim 10, further comprising selecting and executing one of the at least one AP using the AP menu.

15. The method of claim 14, wherein the AP menu comprises an initial menu that displays a plurality of icons for the at least one AP in the area, and
wherein the selecting and executing comprises selecting one of the plurality of icons corresponding to the one of the at least one AP.

16. The method of claim 14, wherein the AP menu comprises an initial menu that displays a plurality of icons for the at least one AP in the area,
wherein if one of the plurality of icons is selected, a corresponding AP among the at least one AP is executed and displayed on the area, or a hierarchical lower level menu with respect to the corresponding AP is displayed in the area.

17. The method of claim 16, wherein if one of the other plurality of icons is selected, the corresponding AP is executed and displayed in the area.

18. The method of claim 14, wherein the selecting and executing comprises analyzing a direction of a 4-direction key input by a user and moving a cursor within the AP menu.

19. The method of claim 10, wherein the area where the AP menu is displayed is the same as an area where a sub-screen in a Picture-In-Picture (PIP) format is displayed.

20. A computer-readable medium having embodied thereon a computer program for executing a method of displaying an application program (AP) menu on an image display unit of a multimedia reproducing apparatus, the method comprising:
creating an AP menu, for selecting at least one AP, by using data for the at least one AP;
composing an image and the AP menu such that the AP menu is displayed in an area of the image display unit; and
displaying the composed image.
